(19) United States
(12) Patent Application Publication
(10) Pub. No.: US 2022/0098127 A1
(43) Pub. Date: Mar. 31, 2022

(54) PHASE-STABILIZED AMMONIUM NITRATE EXPLOSIVES

(71) Applicant: Dyno Nobel Asia Pacific Pty Limited, Southbank (AU)

(72) Inventors: Jeff Gore, Singleton NSW (AU); Brian Graham, Singleton NSW (AU)

(21) Appl. No.: 17/389,135

(22) Filed: Jul. 29, 2021

(30) Foreign Application Priority Data
Jul. 31, 2020 (AU) 2020902693

(51) Int. Cl. C06B 31/28

(52) U.S. Cl. CPC C06B 31/28

(57) ABSTRACT

Phase-stabilized ammonium nitrate (PSAN) explosives containing PSAN prills and a fuel are provided. The PSAN prills contain ammonium nitrate, a potassium salt, and an inorganic porosity enhancing agent.

### CROSS-REFERENCE TO RELATED APPLICATIONS

This application claims priority to Australian Provisional Patent Application No. 2020902693, entitled PHASE-STABILIZED AMMONIUM NITRATE EXPLOSIVES, filed Jul. 31, 2020, which is hereby incorporated by reference in its entirety.

### TECHNICAL FIELD

The present disclosure relates generally to explosives. More specifically, the present disclosure relates to phase-stabilized ammonium nitrate (PSAN) explosives.

### BRIEF DESCRIPTION OF THE DRAWINGS

The embodiments disclosed herein will become more fully apparent from the following description and appended claims, taken in conjunction with the accompanying drawings.

FIG. 1 is a graph showing the crush strength versus thermal cycles of ammonium nitrate fuel oil (ANFO) made with conventional ammonium nitrate (AN) prills and ANFO made with exemplary PSAN prills.

FIG. 2 is a graph showing the temperature of PSAN prills compared to conventional LDAN prills when cycled in an oven.

FIG. 3 is a graph showing the time taken to heat PSAN prills to 50° C. compared to conventional LDAN prills.

FIG. 4 is a graph showing the time taken to cool PSAN prills from 50° C. compared to conventional LDAN prills.

FIG. 5 is graph showing DSC of conventional LDAN prills.

FIG. 6 is a graph showing DSC of PSAN prills.

### DETAILED DESCRIPTION

Phase-stabilized ammonium nitrate (PSAN) explosives are disclosed herein, along with related methods. It has been discovered that PSAN prills including an inorganic porosity enhancing agent, such as aluminum sulfate, have thermal stability, even in the presence of fuel.

Thermal cycling of ammonium nitrate (AN) above and below about 32° C. results in crystal phase changes. Thermal cycling of AN prill results in expansion and contraction of the AN prill with each associated crystalline phase change. Crystalline phase changes of AN also occur at other temperatures as shown in Table 1.

TABLE 1
Crystalline Phases of AN

| | Temperature | | Volume change |
|---|---|---|---|
| System | (° C.) | State | (%) |
| | >169.6 | liquid | |
| I | 169.6 to 125.2 | cubic | −2.1 |
| II | 125.2 to 84.2 | tetragonal | +1.3 |
| III | 84.2 to 32.3 | α-rhombic | −3.6 |
| IV | 32.3 to −16.8 | β-rhombic | +2.9 |
| V | −16.8 | tetragonal | |

The mechanism of expansion and contraction of the AN prill can negatively impact the integrity and/or stability of the AN prill. For example, the expansion and contraction can result in: i) weakening of the AN prill; ii) an increase in AN fine formation (e.g., the AN prill may break down); iii) an increase in friability of the AN prill; and/or iv) an increase of moisture ingress into the AN prill. These characteristics or effects can contribute to caking of the AN prill, which can result in processing and handling problems, loss of free flow behavior, and/or out of specification product. This applies to AN prill mixed with a liquid fuel, such as no. 2 fuel oil, as well.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

As the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the embodiments described herein without departing from the underlying principles of the present disclosure.

PSAN explosives as provided herein may exhibit significantly increased shelf life in comparison to conventional or standard low density ammonium nitrate (LDAN) prill-based explosives, for example, during summer months when temperatures can frequently cycle above and below 32° C. Accordingly, the PSAN explosives may be sent to or used in tropical regions and have increased shelf life compared to conventional LDAN ANFO. The PSAN explosives may significantly reduce health, safety, and/or environmental risks associated with caked and/or blocky ANFO. The PSAN explosives may negate the need for temperature controlled storage infrastructure (e.g., air conditioned ANFO storage sheds). The PSAN explosives may increase flexibility in planning for ANFO supply to customers. The PSAN explosives may reduce or eliminate product delivery bottlenecks. Furthermore, the PSAN explosives may be used in multiple markets (e.g., Asia Pacific and North America).

PSAN explosives and methods of preparing PSAN prills and explosives are disclosed herein. It will be readily understood that the components of the embodiments as generally described below could be arranged and designed in a wide variety of different configurations. Thus, the following more detailed description of various embodiments, as described below and described in the Figures, is not intended to limit the scope of the disclosure, but is merely representative of various embodiments.

An aspect of the disclosure is directed to phase-stabilized ammonium nitrate (PSAN) explosives. The PSAN explosives can include a PSAN prill and a fuel. In some embodiments, the PSAN prill may include from 0.5 mole percent (mol %) to 5 mol % potassium ions of the potassium salt based on the ammonium ions of the ammonium nitrate. In various embodiments, the mol % of the potassium ions based on the ammonium ions may be from 2 mol % to 5 mol %, 2 mol % to 4 mol %, 2.1 mol % to 4.0 mol %, or about 3 mol %. In contrast, conventional or standard low density ammonium nitrate (LDAN) prill or LDAN prill-based explosives can refer to LDAN prill or LDAN prill-based explosives lacking potassium salts or ions. The PSAN prill can be explosive grade. In certain embodiments, the PSAN prill may be low density (“low density” prill has a bulk density of 0.84 kg/L or less).

“Explosive grade” AN prill has a minimum porosity of at least 5.7 FOR %. Explosive grade, low density AN (LDAN) prill is generally manufactured to include available and non-available porosity, such as by incorporation of a suitable porosity forming agent into the concentrated ammonium nitrate solution prior to prilling. Explosive grade prill is generally manufactured to include available and non-available porosity that allows for the absorption of sufficient fuel oil so that the material may be detonated effectively. To determine if the porosity is suitable for manufacturing blasting agents, the ability of the prill to absorb diesel fuel oil is used. Functional determination of the porosity may be performed using a fuel oil retention test, in which a weighed quantity of AN prill is added to a weighed quantity of fuel oil and mixed for a specified time. Excess fuel oil is removed using absorbent paper tissue, the total mass of the formed ANFO product is recorded, and the percent increase in mass calculated. The porosity of the PSAN prill as determined by fuel oil retention percent (FOR %) may be from 6 FOR % to 15 FOR %, 6 FOR % to 12 FOR %, or 5.5 FOR % to 9 FOR %. It is often preferred that the porosity is such that the fuel oil absorption level is at least 5.7 FOR %, so that an acceptable oxygen balance is achieved when enough fuel oil is added to the PSAN prill to produce ANFO. Calculation of the total porosity, including non-available porosity, can be determined in a suitable fluid medium.

The following method may be used to measure FOR %, which correlates to the porosity of prilled ammonium nitrate. The method measures the increase in mass of a selected sample of prill after total immersion in diesel fuel oil (DFO) and removal of excess DFO using paper towel. This method can be a quality check used in product raw material evaluation. First, 40 g (+−0.05 g) sample of AN prill (fines removed) can be weighed into a labelled and tared 250 mL screw top sample jar. This is recorded as the ‘Initial Weight’. Then 6.5 mL of DFO can be added and distributed evenly over the sample. The lid is tightly screwed closed and can be shaken vigorously for 30 seconds. The sample jar can then be placed on the bottle roller and the machine operated for 20 minutes at 40 rpm. After 20 minutes, the jar can be tapped on the bench to remove prill stuck to the lid. Two strips of blotting paper can be placed: one wound loosely to fit along the sides of the jar; the second strip wound tightly and inserted into the center of the first strip of blotting paper. The lid can be replaced, then the jar shaken by hand for 3 minutes. The prill should roll freely in the jar. The sample jar can be placed on the bottle roller and the machine operated for 15 minutes at 40 rpm. The prill should spread out evenly along the length of the jar, and the roller can be adjusted to achieve this. The absorbent paper strips can then carefully be removed, ensuring no prill is removed from the jar. The prill can be transferred to a tared 100 mL beaker and weighed to the nearest 0.05 g. This is recorded as the ‘Final Weight’. The % Fuel Oil Retention (FOR) can be calculated as follows:

FOR (%)=((Final Weight−Initial Weight)/Final Weight)×100

The PSAN prill also includes an inorganic porosity enhancing agent. The inorganic porosity enhancing agent may include an interfacial surface modifier and/or a pore former. The interfacial surface modifier may also be a crystal habit modifier. Examples of the inorganic porosity enhancing agent include aluminum sulfate, either anhydrous or in any of its hydrate forms, iron sulfate, magnesium oxide, or any multivalent sulfate. The inorganic porosity enhancing agent may also include additives. In certain embodiments, the inorganic porosity enhancing agent does not contain iron sulfate, magnesium oxide, or either compound. In certain embodiments, the inorganic porosity enhancing agent comprises aluminum sulfate.

In certain embodiments, the concentration of the inorganic porosity enhancing agent may be from 400 ppm to 4,000 ppm, such as, for example, from 400 ppm to 1,000 ppm, from 500 ppm to 900 ppm, from 600 ppm to 800 ppm, or about 700 ppm, or such as, for example, from 2,000 ppm to 4,000 ppm, from 2,500 ppm to 3,900 ppm, from 3,000 ppm to 3,700 ppm, or about 3,500 ppm.

The potassium salt may be any potassium salt, such as selected from at least one of potassium hydroxide, potassium nitrate, potassium sulfate, potassium hydrogen sulfate, potassium carbonate, and potassium hydrogen carbonate. In some embodiments, the potassium may be selected from at least one of potassium hydroxide, potassium nitrate, and potassium sulfate.

In some embodiments, the PSAN prill may include from 0.5 mol % to 5 mol % potassium ions of potassium hydroxide based on the ammonium ions of the ammonium nitrate (which corresponds to a weight percent (wt %) of 0.4 wt % to 4 wt % potassium hydroxide based on the ammonium nitrate). In various embodiments, the mol % of the potassium ions based on the ammonium ions may be from 2 mol % to 5 mol % (about 1.5 wt % to 4 wt % potassium hydroxide), 2 mol % to 4 mol % (about 1.5 wt % to 3 wt % potassium hydroxide), 2.1 mol % to 4.0 mol % (about 1.5 wt % to 3 wt % potassium hydroxide), or about 3 mol % (about 2 wt % potassium hydroxide).

In certain embodiments, the PSAN prill may include from 0.5 mol % to 5 mol % potassium ions of potassium nitrate based on the ammonium ions of the AN (1 wt % to 6 wt % potassium nitrate based on the AN). In various embodiments, the mol % of the potassium ions based on the ammonium ions may be from 2 mol % to 5 mol % (about 3 wt % to 6 wt % potassium nitrate), 2 mol % to 4 mol % (about 3 wt % to 5 wt % potassium nitrate), 2.1 mol % to 4.0 mol % (about 3 wt % to 5 wt % potassium nitrate), or about 3 mol % (about 4 wt % potassium nitrate).

In various embodiments, the PSAN prill may include from 0.5 mol % to 5 mol % potassium ions of potassium sulfate based on the ammonium ions of the ammonium nitrate (1 wt % to 10 wt % potassium sulfate based on the ammonium nitrate). In various embodiments, the mol % of the potassium ions based on the ammonium ions may be from 2 mol % to 5 mol % (about 5 wt % to 10 wt % potassium sulfate), 2 mol % to 4 mol % (about 5 wt % to 8 wt % potassium sulfate), 2.1 mol % to 4.0 mol % (about 5 wt % to 8 wt % potassium sulfate), or about 3 mol % (about 6 wt % potassium sulfate).

In some embodiments, the bulk density of the PSAN prill may be less than 0.9 kg/L. Furthermore, the PSAN prill may lack, or substantially lack, a 32° C. crystalline phase change. Alternatively, the 32° C. crystalline phase change may be shifted to a temperature higher than 50° C. The PSAN prill may lack, or substantially lack, an 84° C. crystalline phase change. Alternatively, the 84° C. crystalline phase change may be shifted to a temperature higher than 90° C. or 95° C. In certain embodiments, the presence of the 32° C. crystalline phase change and/or the 84° C. crystalline phase change may be determined by thermal analysis and/or x-ray diffraction measurements. For example, the thermal analysis may include differential scanning calorimeter (DSC) and/or thermogravimetric analyzer analysis (TGA) analysis. “Substantial lack” of a 32° C. phase change may correspond to a sufficient removal of the phase change that the PSAN prill can be thermally cycled 50 times and stay within customer specifications, such as the specifications listed in Table 2.

In various embodiments, upon thermal cycling the PSAN explosive 50 times, the thermal cycled PSAN explosive may have an average crush strength greater than 0.4 kg, such as from 0.4 kg to 2.0 kg, 0.5 kg to 1.5 kg, 0.6 kg to 1.0 kg, or 0.7 kg to 0.9 kg. One cycle can include exposing the PSAN explosive to 15° C. for four hours followed by four hours at 45° C.

In some embodiments, upon thermal cycling the PSAN explosive 20 times (the “test PSAN explosive”), an average crush strength of the thermal cycled PSAN explosive may be greater than the average crush strength of non-thermal cycled control PSAN explosive. One cycle includes exposing the PSAN explosive to 15° C. for four hours followed by four hours at 45° C. The test PSAN explosive and the control PSAN explosive include the same components; however, while the test PSAN explosive is subjected to thermal cycling, the control PSAN explosive is not subjected to thermal cycling.

The average crush strength of the thermal cycled PSAN explosive may be from 5% to 100% greater than the average crush strength of the non-thermal cycled control PSAN explosive. In other embodiments, the average crush strength of the thermal cycled PSAN explosive may be from 25% to 100% greater than the average crush strength of the non-thermal cycled control PSAN explosive. In certain embodiments, the average crush strength of the thermal cycled PSAN explosive may be from 10% to 80%, 20% to 60%, or 25% to 40% greater than the average crush strength of the non-thermal cycled control PSAN explosive. And in other embodiments, the average crush strength of the thermal cycled PSAN explosive may be from 35% to 90%, 45% to 80%, or 55% to 70% greater than the average crush strength of the non-thermal cycled control PSAN explosive. Thus, thermal cycling can be used to increase the hardness of the PSAN explosives.

Crush strength may be determined by the following method. All equipment including gloves should be dry and the samples sealed in an airtight container when stored. Samples are prepared by first weighing 250 g of ANFO final product sample and transferring to the top of a sieve stack consisting of a 2.36 mm sieve, a 2.00 mm sieve, and a collection pan. The samples and the sieve stack are placed in a sieve shaker for 10 minutes with an amplitude setting of 60. The fines in the receiving pan and the oversized in the 2.36 mm sieve are discarded. A fraction of the sample from the 2.00 mm sieve is taken to be used for crush testing. For the crush test, 20 individual ANFO particles (AN prills+fuel oil) from the 2.00 mm sieve are randomly selected. A crush test apparatus comprising a force gauge meter (such as model M5-5) and a test stand stage (such as a motorized test stand ESM301L) is used to record KgF units. A particle is placed in the center of the test stand stage. The force gauge meter is zeroed out. The force gauge piston is lowered to crush the test particle. After the force gauge is fully extended, the applied force is recorded as the crush resistance. This process is performed for each of the 20 particles. Crush resistance is calculated as the average crush resistance of the 20 particles.

The shelf life of the PSAN explosives as provided herein may be at least six months. For example, the PSAN explosives may have a shelf life of up to six months or more (such as at least two months, at least four months, or at least six months) while being stored during a hot summer period with an average daytime ambient temperature from 30° C. to 50° C. and average nighttime temperature of 10° C. to 30° C. By contrast, the shelf life of conventional LDAN ANFO, without the aid of temperature-controlled storage, would be much less.

The PSAN prill of the PSAN explosive may have crystal domains that are more tightly packed and more uniform than the crystal domains of an explosive grade ammonium nitrate prill devoid of potassium. Without wishing to be bound by theory, the more tightly packed crystal domains of the PSAN prill may contribute to the improved hardness of the PSAN prill, as compared to conventional LDAN prill. Without wishing to be bound by theory, it is believed that a combination of potassium and a porosity enhancing agent may contribute to the more tightly packed and more uniform crystal domains of the PSAN prill. Thus, the combination of potassium and a porosity enhancing agent may contribute to the surprisingly increased crush strength of the PSAN prills, all while maintaining the porosity and low density of the prills. The crystal domains may be determined by Scanning Electron Microscope with Energy Dispersive Spectroscopy (SEM-EDS).

The PSAN prill may have potassium uniformly distributed throughout the prill. When the PSAN prill includes an interfacial surface modifier containing an alkyl group (such as part of a polymer), then the PSAN prill may have carbon uniformly distributed throughout the prill.

Examples of the fuel that that can be used with the PSAN prill include, but are not limited to, liquid fuels such as fuel oil, diesel oil, distillate, furnace oil, kerosene, gasoline, and naphtha; waxes such as microcrystalline wax, paraffin wax, and slack wax; oils such as paraffin oils, benzene, toluene, and xylene oils, asphaltic materials, polymeric oils such as the low molecular weight polymers of olefins, animal oils, such as fish oils, and other mineral, hydrocarbon, or fatty oils; and mixtures thereof. Any fuel typically used for or with ANFO may be used.

The weight ratio of the PSAN prill to fuel may be, for example, 80:20 to 97:3, 85:15 to 96:4, 90:10 to 95:5, or 94:6. In certain embodiments, the fuel is not an ammonium nitrate emulsion but is a fuel common to conventional ANFO.

Any combination of the components and the amounts or concentrations thereof described in reference to the PSAN prill or PSAN explosive as provided above may also be incorporated into the methods of preparing the PSAN prill or PSAN explosive. Furthermore, any of the characteristics or measurements of the PSAN prill or PSAN explosive as provided above (e.g., bulk density, average crush strength, and shelf life) may also be applicable to the PSAN prill or PSAN explosive prepared by the disclosed methods.

Another aspect of the disclosure is directed to methods of increasing the hardness (e.g., the average crush strength) of a PSAN explosive. Furthermore, any of the characteristics or measurements of the PSAN explosive as provided above may also be applicable to the PSAN explosive prepared by the methods of increasing the hardness of the PSAN explosive. The method may include providing the PSAN prill as discussed above and thermal cycling the PSAN prill a plurality of times (e.g., at least 10 or at least 20 times). After cycling, an average crush strength of the thermal cycled PSAN explosive may be greater than the average crush strength of non-thermal cycled control PSAN explosive. One cycle may include exposing the PSAN explosive to 15° C. for four hours followed by four hours at 45° C.

Another aspect of the disclosure is directed to methods of preparing a PSAN prill and/or PSAN explosive. The method may include forming a PSAN solution comprising a potassium salt and ammonium nitrate and crystallizing the PSAN solution to form a PSAN prill. The PSAN prill may be explosive grade and low density. The method may further include combining a porosity enhancing agent (e.g., aluminum sulfate) with the PSAN solution. Forming the PSAN solution may include mixing a potassium salt (solution) with water (or process condensate), and reacting the mixture with nitric acid and ammonia to form the PSAN solution, such as in a neutralizer.

In some embodiments, the use of a PSAN solution comprising a potassium salt and ammonium nitrate offers manufacturing advantages in the formation of PSAN prills as compared to conventional AN solutions used in forming conventional LDAN prills which lack potassium salt. These manufacturing advantages can provide debottlenecking opportunities in the plant manufacturing process. For instance, conventional LDAN prill manufacturing often requires the prilling rate to be reduced in hotter and more humid months to ensure formation of prill within the appropriate specifications due to i) the prill temperatures observed at the bottom of the prill tower and/or ii) the prill temperatures observed upon exiting the cooling mechanism (e.g., fluidized bed cooler). No such reduction of the prilling rate is required with the PSAN solutions disclosed herein.

In crystallizing the PSAN solution to form a PSAN prill, liquid droplets of the prill solution are dropped within a prill tower. As the liquid droplets fall, they cool and solidify to form individual prills. After further drying in a pre-dryer dryer and drying drum, and screening to remove over size and under size material, the prills are then transferred to a cooling mechanism (such as a fluidized bed cooler) for further cooling, after which the prills can be further processed (e.g., coated), stored, and/or packaged. Typically, the temperature limit for conventional LDAN prill as it reaches the bottom of the prilling tower is 78° C. to 82° C. This temperature limit ensures that the conventional LDAN prill has completed the Phase II to Phase III crystal phase change at about 84° C. prior to reaching the bottom of the prilling tower. Conventional LDAN prill above this temperature limit at the bottom of the prilling tower may still be undergoing a phase change, resulting in clumping/caking and/or other issues downstream in the manufacturing process. Further, having conventional LDAN prill above this temperature limit at the bottom of the prilling tower is a common problem during prill manufacturing, especially in hot and humid environments (e.g., environments with ambient temperatures from 35° C. to 45° C.).

The temperature for conventional LDAN prill exiting the cooling mechanism (e.g., fluidized bed cooler) is typically required to be less than 30° C. This temperature ensures that the conventional LDAN prill has completed the Phase III to Phase IV crystal phase change at about 32° C. prior to the application of a coating (e.g., an anticaking coating). Conventional LDAN prill exiting the cooling mechanism (e.g., fluidized bed cooler) above this temperature may still be undergoing a phase change, resulting in clumping/caking and/or an otherwise loss of free flow of prill in silos or post coating drums. This can further result in problems trying to remove the prill from the silos or post coating drums and placing it into shipping containers, bulk tippers, etc. Having conventional LDAN prill exiting the cooling mechanism (e.g., fluidized bed cooler) above this temperature is a common problem during prill manufacturing, especially in hot and humid environments (e.g., environments with ambient temperatures from 35° C. to 45° C.). To address these problems, conventional manufacturing techniques reduce the prilling rate from a maximum of around 40 T/hr (ton/hour) to less than 35 T/hr, less than 33 T/hr, less than 30 T/hr, or less than 27 T/hr, especially in hot and humid environments (e.g., environments with ambient temperatures from 35° C. to 45° C.). Stated another way, conventional manufacturing techniques reduce the prilling rate to between 25 T/hr and 35 T/hr, or between 25 T/hr and 30 T/hr, especially in hot and humid environments (e.g., environments with ambient temperatures from 35° C. to 45° C.). Stated yet another way, conventional manufacturing techniques reduce the prilling rate from a designed maximum rate of 100% to a rate of less than 90%, less than 80%, or less than 70% of the designed maximum rate, or to a rate that is between 60% and 90%, between 60% and 80%, or between 60% and 70% of the designed maximum rate, especially in hot and humid environments (e.g., environments with ambient temperatures from 35° C. to 45° C.).

Higher prilling rates can be achieved in hot and humid environments with the PSAN solutions disclosed herein. As previously mentioned, the 32° C. phase change is minimized and/or eliminated, and the 84° C. phase change is shifted to a higher temperature with the PSAN solutions disclosed herein. For instance, the 84° C. phase change can be shifted (or increased) by about 5° C. to about 25° C., or by about 10° C. to about 20° C. In certain embodiments, the 84° C. phase is shifted to 95° C. to 105° C.

Because the 84° C. phase change temperature has been increased, the temperature limit at the bottom of the prilling tower can also be increased without causing manufacturing problems. For instance, the temperature limit for the PSAN prill at the bottom of the prilling tower can be increased to at least 85° C., at least 86° C., at least 87° C., at least 88° C., at least 89° C., or at least 90° C., even in hot and humid environments (e.g., environments with ambient temperatures from 35° C. to 45° C.). Stated another way, the upper temperature limit for the PSAN prill at the bottom of the prilling tower can be increased to 85° C. to 95° C., or 85° C. to 90° C., even in hot and humid environments (e.g., environments with ambient temperatures from 35° C. to 45° C.).

With the 32° C. phase change minimized and/or eliminated, there is also little to no PSAN prill going through the 32° C. phase change after exiting the cooling mechanism (e.g., fluidized bed cooler) and/or during the coating process. As a result, the temperature limit of the PSAN prill exiting the cooling mechanism (e.g., fluidized bed cooler) can be increased. In some embodiments, the temperature limit is increased to at least 35° C., at least 36° C., at least 37° C., at least 38° C., at least 39° C., or at least 40° C., even in hot and humid environments (e.g., environments with ambient temperatures from 35° C. to 45° C.). Stated another way, the temperature limit is increased to between 30° C. to 40° C., between 32° C. to 40° C., or between 35° C. to 40° C., even in hot and humid environments (e.g., environments with ambient temperatures from 35° C. to 45° C.). Further, with the 32° C. phase change minimized and/or eliminated, the PSAN prill also exits the cooling mechanism (e.g., fluidized bed cooler) at a cooler temperature than convention LDAN as less heat energy is released by the PSAN prill due to the lack of a phase change. For instance, in some embodiments, the PSAN prill exits the cooling mechanism (e.g., fluidized bed cooler) at a temperature of 2° C. to 5° C., or 3° C. to 4° C. cooler than conventional LDAN at the same manufacturing conditions, even in hot and humid environments (e.g., environments with ambient temperatures from 35° C. to 45° C.).

One or more of i) the increased temperature limit for PSAN prill at the bottom of the prilling tower and ii) the minimized 32° C. phase change temperature also enables the manufacturing process to maintain the plant designed maximum prilling rate, or a higher prilling rate, such as greater than 35 T/hr, greater than 36 T/hr, greater than 37 T/hr, greater than 38 T/hr, greater than 39 T/hr, or greater than 40 T/hr, even in hot and humid environments (e.g., environments with ambient temperatures from 35° C. to 45° C.). Stated another way, the prilling rate of the PSAN prill solutions disclosed herein can be from 35 T/hr to 42 T/hr, or from 38 T/hr to 41 T/hr, even in hot and humid environments (e.g., environments with ambient temperatures from 35° C. to 45° C.). Stated yet another way, the maximum prilling rate of PSAN prill solutions disclosed herein can be at least 10%, at least 20%, at least 30%, at least 40%, or at least 50% higher than maximum prilling rates obtained with conventional LDAN prill solutions, or the maximum prilling rate of the PSAN prill solutions disclosed herein can be from 10% to 60% higher, from 10% to 50% higher, from 10% to 40% higher, from 10% to 30% higher, or from 10% to 20% higher than maximum prilling rates obtained with conventional LDAN prill solutions, even in hot and humid environments (e.g., environments with ambient temperatures from 35° C. to 45° C.).

### EXAMPLES

The following examples are illustrative of disclosed methods and compositions. In light of this disclosure, those of skill in the art will recognize that variations of these examples and other examples of the disclosed methods and compositions would be possible without undue experimentation.

### Example 1—Generation of Prilloids for Analysis

To generate the prilloids, the following method was used. 2.8 mm diameter holes were drilled into the top of a 5 mm thick TEFLON™ plate to a depth of approximately 3 mm. 0.9 mm diameter drainage holes were drilled into those holes. AN solution was then added to the plate to fill the 2.8 mm holes. Once the prilloids cooled, they were pushed out of the 2.8 mm holes in the TEFLON™ plate via the drainage holes.

### Example 2—Analysis of Potassium Salts

Prilloids were manufactured that included aluminum sulfate (either aluminum sulfate solution from Ixom Chemicals or aluminum sulfate from Merck BDH) in addition to AN and a potassium salt in the initial solution. The following samples were prepared for analysis: 1) ANFO only (94:6), 2) AN including 0.07% Al₂SO₄ (700 ppm) and 3.5 mol % KNO₃ combined with fuel oil with dye (94:6), 3) AN including 0.07% Al₂SO₄ and 2.5 mol % KNO₃ combined with fuel oil with dye (94:6), and 4) AN including 3,500 ppm Al₂SO₄ and 2.5 mol % KNO₃ combined with fuel oil with dye (94:6).

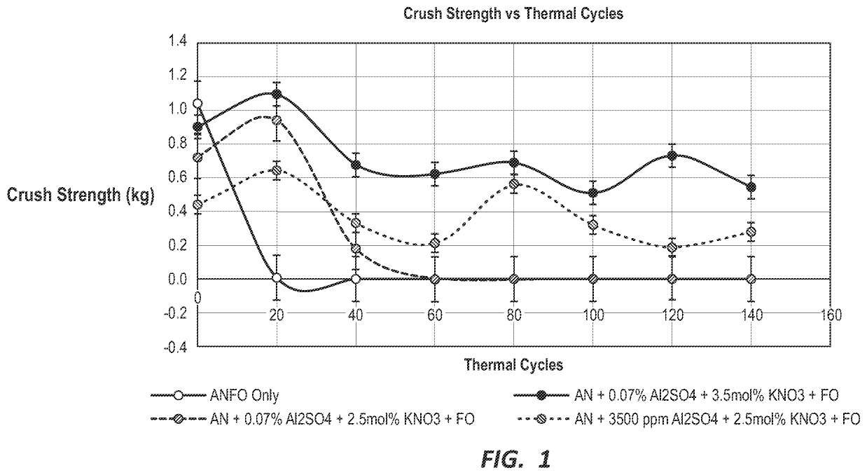

The samples were placed into a cycling oven (PANASONIC™ MIR-254 Cooled Incubator). The cycling oven was designed to mimic the thermal cycling that occurs in the field. The oven was set such that one cycle included a four-hour period at 15° C. followed by a four-hour period at 45° C. The samples were cycled a total of 140 times (Table 2 and FIG. 1).

TABLE 2
Crush Testing Data for PSAN ANFO with Aluminum Sulfate

| | Average Crush | | | | | | |
|---|---|---|---|---|---|---|---|
| | Strength | | | | | | |
| | (ACS) (kg) | | % Change | | % Change | | % Change |
| Sample | Initial | ACS (kg) | from Initial | ACS (kg) | from Initial | ACS (kg) | from Initial |
| Batch | (0 cycles) | 20 cycles | ACS (20 cycles) | 40 cycles | ACS (40 cycles) | 60 cycles | ACS (60 cycles) |
| 1 | 1.037 | 0.007 | −99.3 | Unable to Crush - | | Unable to Crush - | |
| | | | | Sample is powder | | Sample is powder | |
| 2 | 0.900 | 1.085 | 20.6 | 0.673 | −25.2 | 0.615 | −31.7 |
| 3 | 0.727 | 0.941 | 29.4 | 0.179 | −75.4 | Unable to Crush - | |
| | | | | | | Sample is powder | |
| 4 | 0.440 | 0.634 | 44.1 | 0.331 | −24.8 | 0.211 | −52 |

| | ACS (kg) | | % Change | | % Change | | % Change |
|---|---|---|---|---|---|---|---|
| Sample | Initial | ACS (kg) | from Initial | ACS (kg) | from Initial | ACS (kg) | from Initial |
| Batch | (0 cycles) | 80 cycles | ACS (80 cycles) | 100 cycles | ACS (100 cycles) | 120 cycles | ACS (120 cycles) |
| 1 | 1.037 | Unable to Crush - | | Unable to Crush - | | Unable to Crush - | |
| | | Sample is powder | | Sample is powder | | Sample is powder | |
| 2 | 0.900 | 0.688 | −23.6 | 0.507 | −43.7 | 0.728 | −19.1 |
| 3 | 0.727 | Unable to Crush - | | Unable to Crush - | | Unable to Crush - | |
| | | Sample is powder | | Sample is powder | | Sample is powder | |
| 4 | 0.440 | 0.554 | 25.9 | 0.321 | −27.0 | 0.194 | −55.9 |

| | | | |
|---|---|---|---|
| | ACS (kg) | | % Change |
| Sample | Initial | ACS (kg) | from Initial |
| Batch | (0 cycles) | 140 cycles | ACS (140 cycles) |

| | | |
|---|---|---|
| 1 | 1.037 | Unable to Crush - |
| | | Sample is powder |

| | | | |
|---|---|---|---|
| 2 | 0.900 | 0.539 | −40.1 |

| | | |
|---|---|---|
| 3 | 0.727 | Unable to Crush - |
| | | Sample is powder |

| | | | |
|---|---|---|---|
| 4 | 0.440 | 0.284 | −35.5 |

Throughout the cycling process, the condition and possible degradation of the samples were visually observed. Also, crush testing was performed at various points to demonstrate possible changes in hardness of the samples throughout the cycling process (using a Mark-10 ESM303 Motorized Test Stand and Mark-10 Digital Force Gauge M5-20).

Samples were tested for crush strength (hardness) throughout the process of thermal cycling. Crush testing was performed at the points indicated in FIG. 1. These data indicate that the extended shelf life demonstrated with Phase Stabilized AN may be replicated for ANFO manufactured with PSAN using aluminum sulfate as the internal additive.

### Example 3—Generation of PSAN Prills in a Plant and Comparison to LDAN Prills

The following samples were manufactured via a Kaltenbach Thuring process: PSAN Sample 1—PSAN prills containing AN and 2.5 mol % KOH (49% KOH solution); and PSAN Sample 2—PSAN prills containing AN and 3.5 mol % KOH (49% KOH solution).

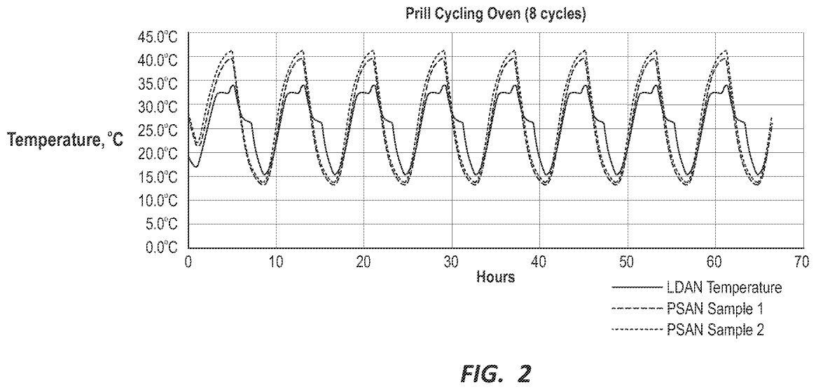

Using thermocouples and data loggers, the temperature of conventional LDAN and PSAN Samples 1 and 2 were measured over eight (8) thermal cycles. For each thermal cycle the samples were subjected to 4 hours at 45° C. followed by 4 hours at 15° C. Under these conditions, PSAN Samples 1 and 2 reached the high and low temperatures in the oven easily, whereas the conventional LDAN did not actually reach 45° C. within 4 hrs. This is depicted in FIG. 2. The temperature profiles depicted in FIG. 2 also show the endothermic and exothermic behavior of the conventional LDAN (associated with the known 32° C. phase change). As the PSAN Samples 1 and 2 do not have a phase change at 32° C., this was not observed in their temperature profiles.

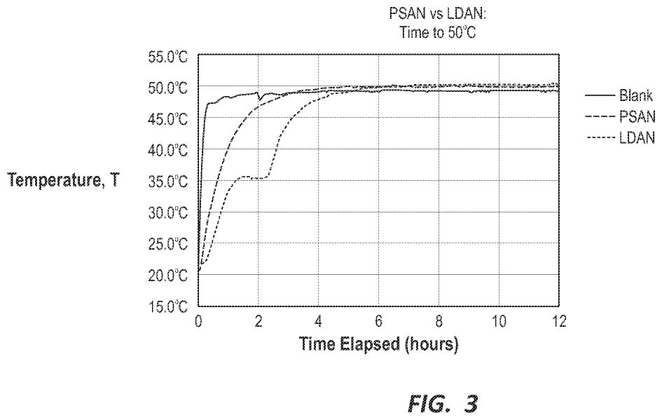

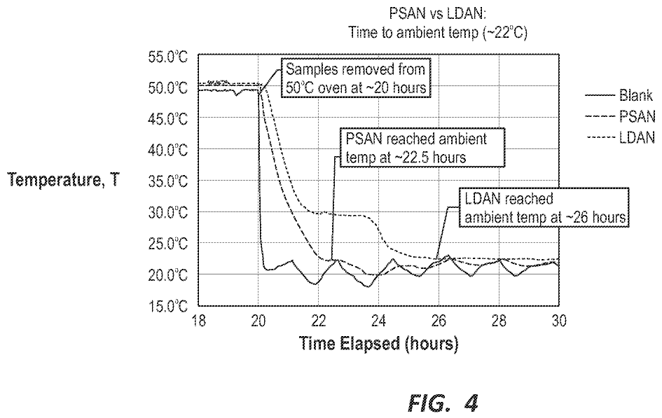

The heating and cooling times of the PSAN prills were then compared to conventional LDAN prills. In doing so, samples of conventional LDAN and PSAN prills were placed in an oven at 50° C.—with thermocouples and data loggers to determine the length of time it takes for each of the samples to reach 50° C. (FIG. 3). The samples were left in the oven overnight, then removed to ambient conditions to determine the time taken to cool the samples to ambient temperature (FIG. 4). Blank control samples (empty jars) were also used. As shown in FIGS. 3 and 4, the PSAN prills heat and cool more rapidly than conventional LDAN prills. This is due to the lack of the 32° C. phase change in the PSAN prills.

### Example 4—Generation of PSAN Prills in a Plant and Comparison to LDAN Prills

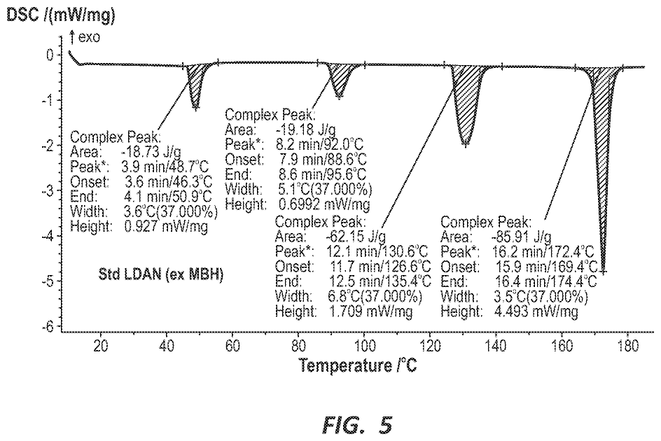

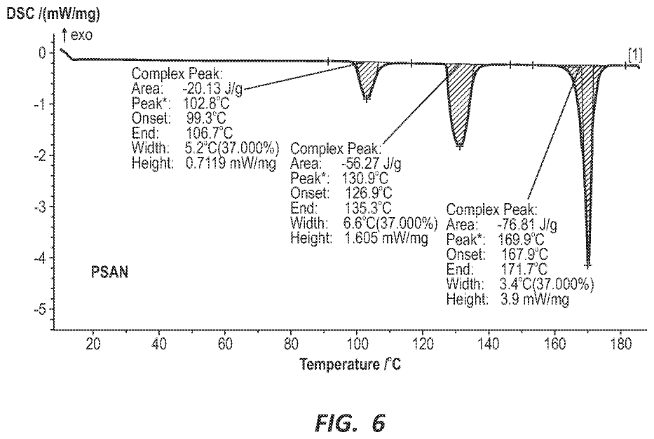

The following sample was manufactured via a Kaltenbach Thuring process: PSAN prills containing AN and 2.5 mol % KOH (49% KOH solution). The PSAN prills were also coated with 700 ppm GALORYL® ATH 626M. FIGS. 5 and 6 show DSC data from conventional LDAN prills (FIG. 5) and the PSAN prills (FIG. 6). As shown therein, the 84° C. phase change in the PSAN prills shifted to approximately 95° C. to 105° C. and the 32° C. was minimized.

The prilling rate was set at 40 T/hr and 6 prill heads were online. The average ambient temperature of the environment was approximately 38° C. As a result of the 84° C. phase change shifting to a higher temperature, the temperature limit at the bottom of the tower was set to 90° C. The PSAN prill temperatures at the bottom of the tower were also measured and depicted in Table 3 below:

TABLE 3

| Time | No of Prill heads online | Bottom Tower Temperature (° C.) |
|---|---|---|
| 10:00 | 6 | 82.4 |
| 10:05 | 6 | 82.2 |
| 10:30 | 6 | 81.9 |
| 10:45 | 6 | 82.0 |
| 11:00 | 6 | 81.8 |
| 12:00 | 6 | 83.9 |
| 14:00 | 6 | 85.3 |
| 15:00 | 6 | 85.7 |
| 18:00 | 6 | 83.7 |
| 20:00 | 6 | 82.7 |
| 22:00 | 6 | 82.8 |

As shown in Table 3, the temperature of the PSAN prills at the bottom of the tower (from 82° C. to 86° C.) exceeded the temperature range capable of being achieved with conventional LDAN prill production (78° C. to 82° C.).

As a result of the 32° C. phase change being minimized, the temperature for the PSAN prill exiting the cooling mechanism (e.g., fluidized bed cooler) was set to 35° C. The temperature of the PSAN prill was also observed as it exited the cooling mechanism (e.g., fluidized bed cooler (FBC)). This temperature is depicted in Table 4 below:

TABLE 4

| Time | No. of Prill heads online | Prill temp (ex FBC) |
|---|---|---|
| 11:25 | 6 | 26.4 |
| 13:00 | 6 | 24.6 |
| 17:00 | 6 | 25.6 |
| 21:00 | 6 | 25.2 |
| 22:00 | 6 | 24.2 |

Typically, temperatures observed for conventional LDAN prill would be in the range of 29° C. to 30° C. when the ambient environmental temperature is greater than 35° C., which would require the prilling rate to be reduced. However, the PSAN prill exited the cooling mechanism (e.g., fluidized bed cooler) at a lower temperature (from 24° C. to 27° C.) due to the absence of the 32° C. phase change.

As a comparison, the following manufacturing parameters were achieved with the PSAN prill vs conventional LDAN prill:

TABLE 5

| | | |
|---|---|---|
| Bottom Tower | Conventional LDAN | PSAN |
| Temperature Range Without | 78° C. to 82° C. | 78° C. to 90° C. |
| Production Issues | | |
| Maximum Production Rate | 27 T/hr | 40 T/hr |
| with Hot Environment | | |
| Conditions (35° C. to 45° C.) | | |

TABLE 6

| | | |
|---|---|---|
| Cooling Mechanism | Conventional | PSAN |
| (Fluidized Bed Cooler) | LDAN | |
| Exit Temperature | | |
| Temperature Range | Less than 30° C. | Up to 35° C. |
| Without Production | | (25° C. to 26° C. observed) |
| Issues | | |
| Maximum Production | 27 T/hr | 40 T/hr |
| Rate with Hot | | |
| Environment Conditions | | |
| (35° C. to 45° C.) | | |

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art, and having the benefit of this disclosure, that changes may be made to the details of the above-described embodiments without departing from the underlying principles of the disclosure herein.

1. A phase-stabilized ammonium nitrate (PSAN) explosive comprising:
a PSAN prill comprising:
ammonium nitrate;
a potassium salt, wherein the PSAN prill comprises from 0.5 mole percent (mol %) to 5 mol % potassium ions of the potassium salt based on the ammonium ions of the ammonium nitrate; and
an inorganic porosity enhancing agent;
and a fuel.

2. The PSAN explosive of claim 1, wherein the mol % of the potassium ions based on the ammonium ions is from 2 mol % to 5 mol %, 2 mol % to 4 mol %, 2.1 mol % to 4 mol %, or about 3 mol %.

3. The PSAN explosive of claim 1, wherein the fuel comprises a liquid fuel, including fuel oil, diesel oil, distillate, furnace oil, kerosene, gasoline, or naphtha; waxes including microcrystalline wax, paraffin wax, or slack wax; oils including paraffin oils, benzene, toluene, or xylene oils, asphaltic materials, polymeric oils, animal oils, or other mineral, hydrocarbon, or fatty oils; and mixtures thereof.

4-6. (canceled)

7. The PSAN explosive of claim 1, wherein the inorganic porosity enhancing agent comprises aluminum sulfate.

8. The PSAN explosive of claim 1, wherein the concentration of the inorganic porosity enhancing agent in the prill is from 400 ppm to 4,000 ppm, from 400 ppm to 1,000 ppm, from 500 ppm to 900 ppm, from 600 ppm to 800 ppm, about 700 ppm, 2,000 ppm to 4,000 ppm, from 2,500 ppm to 3,900 ppm, from 3,000 ppm to 3,700 ppm, or about 3,500 ppm.

9-20. (canceled)

21. A method of increasing the hardness of a phase-stabilized ammonium nitrate (PSAN) explosive, the method comprising:
providing the PSAN explosive of claim 1, and
thermal cycling the PSAN explosive 20 times or more.

22. The method of claim 21, wherein the average crush strength of the thermal cycled PSAN explosive is increased by at least 5% greater than the average crush strength of a non-thermal cycled control PSAN explosive, including from 5% to 100%, 10% to 80%, 20% to 60%, or 25% to 40% greater than the average crush strength of a non-thermal cycled control PSAN explosive.

23. A method of preparing a phase-stabilized ammonium nitrate (PSAN) prill, the method comprising:
forming a PSAN solution comprising a potassium salt and ammonium nitrate; and
crystallizing the PSAN solution to form a PSAN prill by dropping liquid droplets of the PSAN solution within a prill tower, wherein a temperature limit for the PSAN prill at a bottom of the prill tower is at least 85° C.

24. The method of claim 23, wherein the temperature limit for the PSAN prill at the bottom of the prill tower is at least 86° C., at least 87° C., at least 88° C., at least 89° C., or at least 90° C.

25. The method of claim 23, wherein the temperature limit for the PSAN prill at the bottom of the prill tower is between 85° C. to 95° C. or 85° C. to 90° C.

26. The method of claim 23, further comprising:
combining a porosity enhancing agent with the PSAN solution.

27. The method of claim 23, further comprising:
transferring the PSAN prill to a cooling mechanism.

28. The method of claim 27, wherein the cooling mechanism comprises a fluidized bed cooler.

29. The method of claim 27, wherein a temperature limit for the PSAN prill exiting the cooling mechanism is at least 35° C., at least 36° C., at least 37° C., at least 38° C., at least 39° C., or at least 40° C.

30. The method of claim 27, wherein a temperature limit for the PSAN prill exiting the cooling mechanism is between 30° C. to 40° C., between 32° C. to 40° C., or between 35° C. to 40° C.

31. The method of claim 23, wherein a prilling rate is greater than 35 T/hr, greater than 36 T/hr, greater than 37 T/hr, greater than 38 T/hr, greater than 39 T/hr, or greater than 40 T/hr.

32. The method of claim 23, wherein a prilling rate is from 35 T/hr to 42 T/hr or from 38 T/hr to 41 T/hr.

33. The method of claim 23, wherein a prilling rate is at least 10%, at least 20%, at least 30%, at least 40%, or at least 50% higher than prilling rates obtained with conventional LDAN prill solutions.

34. The method of claim 23, wherein a prilling rate is from 10% to 60% higher, from 10% to 50% higher, from 10% to 40% higher, from 10% to 30% higher, or from 10% to 20% higher than prilling rates obtained with conventional LDAN prill solutions.

35. The method of claim 31, wherein ambient temperature is from 35° C. to 45° C.
